(19) United States
(12) Patent Application Publication
(10) Pub. No.: US 2011/0156633 A1
(43) Pub. Date: Jun. 30, 2011

(54) SOLAR POWER STORAGE SYSTEM AND CHARGE METHOD OF SAME

(75) Inventor: CHIH-CHEN LAI, Tu-Cheng (TW)

(73) Assignee: HON HAI PRECISION INDUSTRY CO., LTD., Tu-Cheng (TW)

(21) Appl. No.: 12/770,742

(22) Filed: Apr. 30, 2010

(30) Foreign Application Priority Data
Dec. 30, 2009 (TW) 98145691

(51) Int. Cl. H01M 10/46

(52) U.S. Cl. 320/101

(57) ABSTRACT

A solar power storage system includes a solar panel, an energy storage device, a transformer, and a controller. The solar panel collects energy from sunlight and outputs an actual output voltage. The energy storage device stores the energy collected from the solar panel. The transformer transforms the actual output voltage of the solar panel into a charge voltage and charges the energy storage device using the charge voltage. The controller is configured for comparing the actual output voltage with a first predetermined voltage to obtain a first comparative result, comparing an instant battery voltage of the energy storage device with a second predetermined voltage to obtain a second comparative result. The transformer adjusts the charge voltage according to the first and the second comparative results.

### BACKGROUND

1. Technical Field

The present disclosure relates to solar power storage systems, and more particularly, to solar power storage system and charge method capable of automatically adjusting charge voltage of the solar power storage system.

2. Description of Related Art

Solar power storage systems typically employ solar cells and an energy storage device. Moreover, solar power storage systems also include a transformer device to transform the electrical energy from the solar cell into a charge voltage to charge the energy storage device. However, the transformer device does not automatically adjust its charge voltage. Therefore, a charge efficiency of the transformer device is low and the solar power storage systems using the transformer device has a low efficiency.

Therefore, a new solar power storage system and a charge method of the same are desired to overcome the above-described shortcomings.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of a solar power storage system according to one embodiment of the present disclosure.

FIG. 2 is a flowchart showing one embodiment of a charge method of the solar power storage system of FIG. 1.

### DETAILED DESCRIPTION

Reference will now be made to the drawings to describe various inventive embodiments of the present disclosure in detail, wherein like numerals refer to like elements throughout.

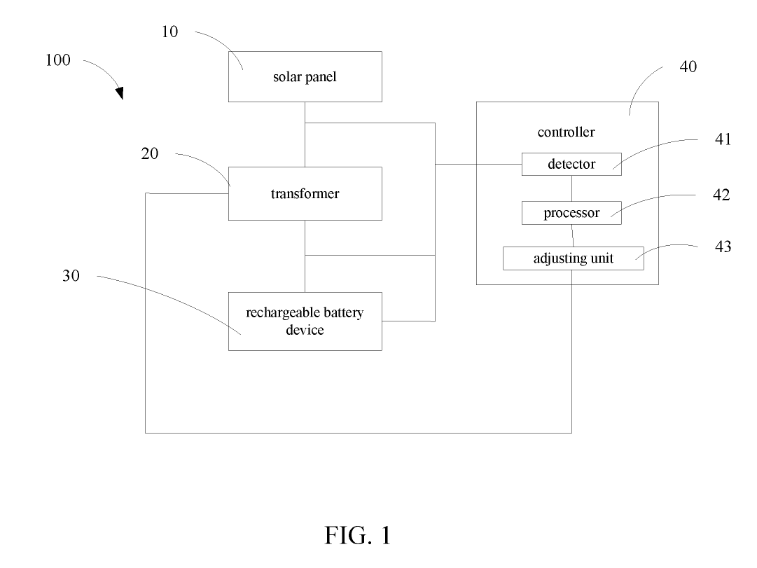

Referring to FIG. 1, a solar power storage system 100 according to one embodiment of the present disclosure is shown. The solar power storage system 100 includes a solar panel 10, a transformer 20, a rechargeable battery device 30, and a controller 40. In one embodiment, rechargeable battery device 30 can also be replaced by other energy storage devices such as capacitor modules.

The solar panel 10 collects energy from sunlight and generates an output voltage. Normally, the pressure of the output voltage changes according to the intensity of the sunlight. For example, when the intensity of the sunlight reaches a maximum value at noon, the solar panel 10 outputs a maximum output voltage. When the intensity of the sunlight decreases to a minimum value at nightfall, the solar panel 10 outputs a minimum output voltage.

The transformer 20 connects between the solar panel 10 and the rechargeable battery device 30. The transformer 20 transforms the output voltage of the solar panel 10 into a charge voltage and provides the charge voltage to the rechargeable battery device 30. The charge voltage can be a direct current (DC) voltage or a pulse voltage depending on the situation. Value of the DC voltage or a frequency of the pulse voltage can be adjusted according to a relationship between an actual output voltage of the solar panel 10 and an instant battery voltage of the rechargeable battery device 30.

The controller 40 includes a detector 41, a processor 42 and adjusting unit 43. The detector 41 connects to an output of the solar panel 10 for detecting the actual output voltage of the solar panel 10. The detector 41 connects an output of the transformer 20 for detecting the charge voltage of the transformer 20. The detector 41 also connects to the anode and the cathode of the rechargeable battery device 30 for detecting an instant battery voltage between the anode and the cathode of the rechargeable battery device 30.

The processor 42 connects to the detector 41 for receiving the actual output voltage of the solar panel 10, the charge voltage of the transformer 20, and the instant battery voltage of the battery device 30 from the detector 41.

The processor 42 compares the actual output voltage with a first predetermined voltage to obtain a first comparative result. The processor 42 also compares the instant battery voltage with a second predetermined voltage to obtain a second comparative result. The first predetermined voltage is greater than the second predetermined voltage. In this embodiment, the first predetermined voltage is approximately equal to a maximum battery voltage of fully charged rechargeable battery device 30. The second predetermined voltage is approximately equal to 80% of the first predetermined voltage. Alternatively, the second predetermined voltage can also be one of voltages in a range of 80%-90% of the first predetermined voltage. The first predetermined voltage and the second predetermined voltage can be pre-stored in the processor 42.

The adjusting unit 43 connects to the transformer 20 and controls the transformer 20 to adjust the charge voltage of the transformer 20 according to the first and the second comparative results.

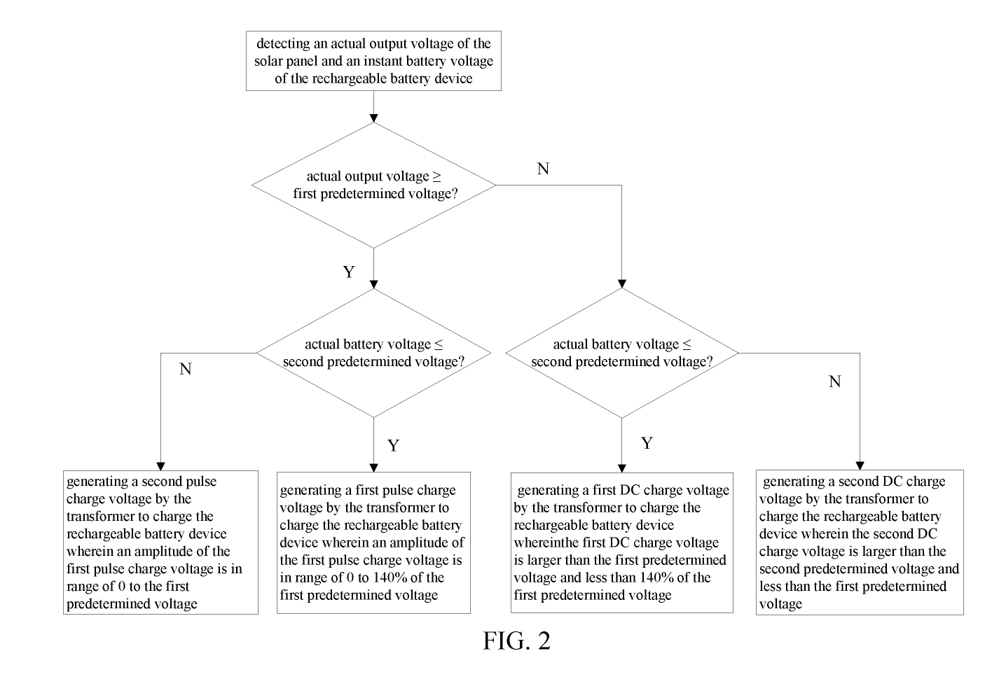

Referring to FIG. 2, description of one embodiment of a charge method of the solar power storage system 100 according to a present disclosure follows.

Firstly, the detector 41 detects an actual output voltage of the solar panel 10 and an instant battery voltage of the rechargeable battery device 30.

Secondly, the processor 42 determines by comparison if the actual output voltage of the solar panel 10 is less than the first predetermined voltage. In this embodiment, the first predetermined voltage is approximately equal to a maximum battery voltage of fully charged rechargeable battery device 30. The first predetermined voltage can be adjusted according to different capacitances of the rechargeable battery device 30.

Thirdly, the processor 42 determines if an actual battery voltage of the rechargeable battery device 30 is less than the second predetermined voltage. In this embodiment, the second predetermined voltage is voltage in a range of 80%-90% of the first predetermined voltage. The second predetermined voltage can be adjusted according to different types of the rechargeable battery device 30.

Fourthly, the adjusting unit 43 controls the transformer 20 to adjust the charge voltage output to the rechargeable battery device 30 according to above comparisons.

In detail, in a first situation, when the actual output voltage of the solar panel 10 is less than the first predetermined voltage, and an instant battery voltage of the rechargeable battery device 30 is less than the second predetermined voltage, the adjusting unit 43 controls the transformer 20 to transform the actual output voltage of the solar panel 10 into a first pulse voltage and charge the rechargeable battery device 30 using the first pulse voltage. In one embodiment, the amplitude of the first pulse voltage is in a range from 0 to 140% of the first predetermined voltage. That is, a high level voltage of the first pulse voltage is approximately equal to 140% of the first predetermined voltage. A low level voltage of the first pulse voltage is approximately equal to zero volts.

In one embodiment, the adjusting unit 43 controls the transformer 20 to adjust a duty of the first pulse voltage according to the instant battery voltage of the rechargeable battery device 30 to avoid generating high temperatures during charging of the rechargeable battery device 30. In detail, when the instant battery voltage of the rechargeable battery device 30 is less than 80% of the second predetermined voltage, the transformer 20 adjusts the first pulse voltage to a first duty cycle. When the instant battery voltage of the rechargeable battery device 30 is greater than 80% of the second predetermined voltage and less than the second predetermined voltage, the transformer 20 adjusts the first pulse voltage to a second duty cycle. The first duty cycle of the first pulse voltage is greater than the second duty cycle of the first pulse voltage. The rechargeable battery device 30 can be quickly charged by the first pulse voltage with the first duty cycle in the beginning and slowly charged by the first pulse voltage with the second duty cycle, subsequently.

In a second situation, when the actual output voltage of the solar panel 10 is less than the first predetermined voltage, but an instant battery voltage of the rechargeable battery device 30 is greater than the second predetermined voltage, the adjusting unit 43 controls the transformer 20 to transform the actual output voltage of the solar panel 10 into a second pulse voltage and charge the rechargeable battery device 30 using the second pulse voltage. In one embodiment, the amplitude of the first pulse voltage ranges from 0 to the first predetermined voltage. That is, a high level voltage of the second pulse voltage is approximately equal to or less than the first predetermined voltage. A low level voltage of the second pulse voltage is approximately equal to zero volts.

In one embodiment, the adjusting unit 43 controls the transformer 20 to adjust a duty cycle of the second pulse voltage according to the instant battery voltage of the rechargeable battery device 30 to avoid overcharging the rechargeable battery device 30. In detail, when the instant battery voltage of the rechargeable battery device 30 is equal to or greater than the second predetermined voltage and less than 95% of the first predetermined voltage, the transformer 20 adjusts the second pulse voltage to a third duty cycle. When the instant battery voltage of the rechargeable battery device 30 is greater than 95% of the first predetermined voltage and less than the first predetermined voltage, the transformer 20 adjusts the second pulse voltage to a fourth duty cycle. The third duty cycle of the second pulse voltage is greater than the fourth duty cycle of the second pulse voltage. In some circumstance the rechargeable battery device 30 can be charged more safely using the second pulse voltage with the third duty cycle and the fourth duty cycle.

In a third situation, when the actual output voltage of the solar panel 10 is greater than the first predetermined voltage, and an instant battery voltage of the rechargeable battery device 30 is less than the second predetermined voltage, the adjusting unit 43 controls the transformer 20 to transform the actual output voltage of the solar panel 10 into a first DC voltage at a steady level such as 5V or 12V and charge the rechargeable battery device 30 using the first DC voltage. In one embodiment, the first DC voltage is approximately greater than the first predetermined voltage and less than 140% of the first predetermined voltage.

In a fourth situation, when the actual output voltage of the solar panel 10 is greater than the first predetermined voltage, and an instant battery voltage of the rechargeable battery device 30 is greater than the second predetermined voltage, the adjusting unit 43 controls the transformer 20 to transform the actual output voltage of the solar panel 10 into a second DC voltage and charge the rechargeable battery device 30 using the second DC voltage. In one embodiment, the second DC voltage is approximately greater than the second predetermined voltage and less than or equal to the first predetermined voltage.

In one alternative embodiment, the controller 40 of the solar power storage system 100 further includes an alarm unit configured to stop the transformer 20 and send out an alarm signal when the rechargeable battery device 30 full charged. In one embodiment, the alarm signal is a blinking signal or a speaking signal.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A solar power storage system, comprising:
a solar panel that outputs an actual output voltage according to energy collected from sunlight;
an energy storage device that stores energy collected from the solar panel;
a transformer that transforms the actual output voltage of the solar panel into a charge voltage and charges the energy storage device using the charge voltage; and
a controller configured for comparing the actual output voltage with a first predetermined voltage to obtain a first comparative result, comparing an instant battery voltage of the energy storage device with a second predetermined voltage to obtain a second comparative result wherein the transformer automatically adjusts the charge voltage according to the first and the second comparative results.

2. The solar power storage system of claim 1, wherein the actual output voltage changes according to the intensity of the sunlight.

3. The solar power storage system of claim 1, wherein the charge voltage is a direct current (DC) voltage or a pulse voltage.

4. The solar power storage system of claim 3, wherein a value of the DC voltage or a frequency of the pulse voltage can be adjusted according to the actual output voltage of the solar panel and the instant battery voltage of the rechargeable battery device.

5. The solar power storage system of claim 1, wherein the energy storage device is a rechargeable battery device, the rechargeable battery device comprising a anode and a cathode.

6. The solar power storage system of claim 5, wherein the controller comprises a detector, a processor and adjusting unit, the detector is configured for detecting the actual output voltage of the solar panel, detecting the charge voltage of the transformer, and detecting the instant battery voltage between the anode and the cathode of the rechargeable battery device, the processor is configured for comparing the actual output voltage with the first predetermined voltage and comparing the instant battery voltage with the second predetermined voltage, the adjusting unit control the transformer to adjust the charge voltage.

7. The solar power storage system of claim 1, wherein the first predetermined voltage is greater than the second predetermined voltage.

8. The solar power storage system of claim 7, wherein the first predetermined voltage is approximately equal to a maximum battery voltage of full charged rechargeable battery device.

9. The solar power storage system of claim 7, wherein second predetermined voltage is approximately equal to 80% of the first predetermined voltage.

10. A charge method of a solar power storage system comprising:
detecting an actual output voltage of a solar panel and an instant battery voltage of an energy storage device;
determining if the actual output voltage of the solar panel is less than a first predetermined voltage to obtain a first determination result;
determining if the actual battery voltage of the energy storage device is less than a second predetermined voltage which is less than the first predetermined voltage to obtain a second determination result; and
adjusting the charge voltage of a transformer to charge the energy storage device according to both the first and the second determination results,
wherein the charge voltage is adjusted to be a first pulse voltage when the actual output voltage of the solar panel is less than the first predetermined voltage, and the instant battery voltage of the rechargeable battery device is less than the second predetermined voltage;
the charge voltage is adjusted to be a second pulse voltage when the actual output voltage of the solar panel is less than the first predetermined voltage, and the instant battery voltage of the energy storage device is greater than the second predetermined voltage;
the charge voltage is adjusted to be a first DC voltage when the actual output voltage of the solar panel is greater than the first predetermined voltage, and the instant battery voltage of the energy storage device is less than the second predetermined voltage; and
the charge voltage is adjusted to be a second DC voltage when the actual output voltage of the solar panel is greater than the first predetermined voltage, and the instant battery voltage of the energy storage device is greater than the second predetermined voltage.

11. The charge method of claim 10, wherein the actual output voltage changes according to the intensity of the sunlight.

12. The charge method of claim 10, wherein the energy storage device is a rechargeable battery device, the rechargeable battery device comprising an anode and a cathode.

13. The charge method of claim 12, wherein the first predetermined voltage is approximately equal to a maximum battery voltage of full charged rechargeable battery device

14. The charge method of claim 13, wherein second predetermined voltage is approximately equal to 80% of the first predetermined voltage.

15. The charge method of claim 10, wherein the first pulse voltage comprises an amplitude in range from 0 to 140% of the first predetermined voltage.

16. The charge method of claim 10, wherein the second pulse voltage comprises an amplitude in range from 0 to the first predetermined voltage.

17. The charge method of claim 10, wherein the first DC voltage is greater than the first predetermined voltage and less than 140% of the first predetermined voltage.

18. The charge method of claim 10, wherein the second DC voltage is greater than the second predetermined voltage and less than or equal to the first predetermined voltage.
